(19) United States
(12) Patent Application Publication
(10) Pub. No.: US 2012/0120431 A1
(43) Pub. Date: May 17, 2012

(54) PRINTING SYSTEM

(75) Inventor: Tetsuro KINO, Tokyo (JP)

(73) Assignee: RICOH COMPANY, LTD.

(21) Appl. No.: 13/289,045

(22) Filed: Nov. 4, 2011

(30) Foreign Application Priority Data
Nov. 15, 2010 (JP) 2010-254827

(51) Int. Cl. G06F 3/12

(52) U.S. Cl. 358/1.13

(57) ABSTRACT

A non-transitory computer-readable recording medium stores a program that causes a computer to execute the steps of causing a first printer driver to generate first print data in response to receiving an electronic data print instruction, and recording the first print data in a storage unit; sending the first print data to an image forming apparatus connected to the computer via a network, in response to receiving a print data acquisition request from the image forming apparatus; causing a printer driver identified by identification information to generate second print data in response to receiving the identification information identifying the printer driver, the printer driver being compatible with the image forming apparatus, and sending the second print data to the image forming apparatus.

### BACKGROUND OF THE INVENTION

1. Field of the Invention

The present invention relates to a printing system.

2. Description of the Related Art

Conventionally, there is a printer server that is positioned between a client PC and an image forming apparatus. The printer server accumulates print jobs that are sent from the client PC, and transfers the accumulated print jobs to the image forming apparatus in response to requests from the image forming apparatus (see, for example, patent document 1). In a printing system including such a printer server, the user first inputs a print instruction in the client PC. The client PC sends a print job according to the print instruction to the printer server. The printer server does not immediately transfer the print job to the image forming apparatus, but stores the print job in a storage device such as an HDD (Hard Disk Drive). Subsequently, the user operates the image forming apparatus, and gives an instruction to print the stored print job. In response to the instruction, the image forming apparatus acquires the print job from the printer server.

According to the above print system, the user can select the image forming apparatus to be used for outputting the print data after giving the print instruction.

However, when there are image forming apparatuses of different machine types, a general-purpose printer driver needs to be used at the client PC. A general-purpose printer driver is not a specialized printer driver that generates specific print data for a particular machine type. The general-purpose printer driver generates highly versatile print data that can be interpreted by image forming apparatuses of various machine types.

However, a general-purpose printer driver may not necessarily be compatible with (may not necessarily be able to handle) all machine types of image forming apparatuses. Assuming that the user operates an image forming apparatus that cannot interpret highly versatile print data to output the print job stored in the printer server, the image forming apparatus cannot output the print data. Then, the user moves to another image forming apparatus and performs the operation, or returns to the client PC and gives a print instruction once again by using a printer driver that is specialized for the image forming apparatus with which the output was unsuccessful. Furthermore, for example, when the user is at a remote location due to a business trip, and there are no image forming apparatuses that can interpret highly versatile print data, the user cannot obtain the expected document.

Patent Document 1: Japanese Laid-Open Patent Publication No. 2007-200284

### SUMMARY OF THE INVENTION

The present invention provides a printing system in which one or more of the above-described disadvantages are eliminated.

A preferred embodiment of the present invention provides a printing system capable of enhancing convenience in a case where the output destination of a print job is not limited when a print instruction is given from a client.

According to an aspect of the present invention, there is provided a printing system including an image forming apparatus; and a program that causes a computer connected to the image forming apparatus via a network to execute a process, the process including a first generating step of causing a first printer driver to generate first print data in response to receiving an electronic data print instruction, and recording the first print data in a storage unit, a first sending step of sending the first print data to the image forming apparatus in response to a print data acquisition request from the image forming apparatus, a second generating step of causing a printer driver identified by identification information to generate second print data, in response to receiving the identification information identifying the printer driver that is compatible with the image forming apparatus, and a second sending step of sending the second print data to the image forming apparatus, wherein the image forming apparatus includes a first acquiring unit configured to acquire the first print data recorded in the storage unit, a print control unit configured to execute a print operation based on the first print data, and a second acquiring unit configured to send, to the computer, the identification information of the printer driver being compatible with the image forming apparatus, and to receive the second print data, when the image forming apparatus cannot print the first print data, wherein the print control unit executes a print operation based on the second print data.

According to an aspect of the present invention, there is provided a printing system including an image forming apparatus; and a program that causes a computer connected to the image forming apparatus via a network to execute a process, the process including a recording step of recording, in a storage unit, an identification name of electronic data in response to receiving an electronic data print instruction, a first sending step of sending the identification name to the image forming apparatus in response to a request from the image forming apparatus, a generating step of causing a printer driver identified by identification information to generate print data corresponding to the electronic data relevant to the identification name, in response to receiving the identification information identifying the printer driver and the identification name of the electronic data, the printer driver identified by the identification information being compatible with the image forming apparatus, and a second sending step of sending the print data to the image forming apparatus, wherein the image forming apparatus includes a first acquiring unit configured to acquire the identification name recorded in the storage unit, a second acquiring unit configured to send, to the computer, the identification information of the printer driver compatible with the image forming apparatus and the identification name, and to receive the print data, and a print control unit configured to execute a print operation based on the print data.

According to an aspect of the present invention, there is provided a non-transitory computer-readable recording medium storing a program that causes a computer to execute the steps of causing a first printer driver to generate first print data in response to receiving an electronic data print instruction, and recording the first print data in a storage unit; sending the first print data to an image forming apparatus connected to the computer via a network, in response to receiving a print data acquisition request from the image forming apparatus; causing a printer driver identified by identification information to generate second print data in response to receiving the identification information identifying the printer driver, the printer driver being compatible with the image forming apparatus, and sending the second print data to the image forming apparatus.

### BRIEF DESCRIPTION OF THE DRAWINGS

Other objects, features and advantages of the present invention will become more apparent from the following detailed description when read in conjunction with the accompanying drawings, in which:

FIG. 1 illustrates an information processing system according to an embodiment of the present invention;

FIG. 2 illustrates a hardware configuration of an image forming apparatus according to an embodiment of the present invention;

FIG. 3 is a hardware configuration of a user terminal according to an embodiment of the present invention;

FIG. 4 illustrates a functional configuration of a widget, a widget manager, and a provider application;

FIG. 5 is a sequence diagram for describing the processing procedures performed when the widget manager and a print widget are activated;

FIG. 6 illustrates an example of a user management table;

FIG. 7 illustrates an example of widget information of the print widget;

FIG. 8 illustrates an example of widget information of a scan widget;

FIG. 9 is a sequence diagram of the processing procedures for registering a print job performed by the print widget according to a first embodiment;

FIG. 10 is a sequence diagram for describing the processing procedures when a print job is executed according to the first embodiment;

FIG. 11 illustrates a display example of a user selection screen image;

FIG. 12 illustrates a display example of a widget selection screen image;

FIG. 13 is a sequence diagram for describing the processing procedures executed when the image forming apparatus that is the output destination is not handled by a common printer driver according to the first embodiment;

FIG. 14 is a sequence diagram of the processing procedures for registering a print job performed by the print widget according to the second embodiment; and

FIG. 15 is a sequence diagram for describing the processing procedures when a print job is executed according to the second embodiment.

### DETAILED DESCRIPTION OF THE PREFERRED EMBODIMENTS

A description is given, with reference to the accompanying drawings, of embodiments of the present invention.

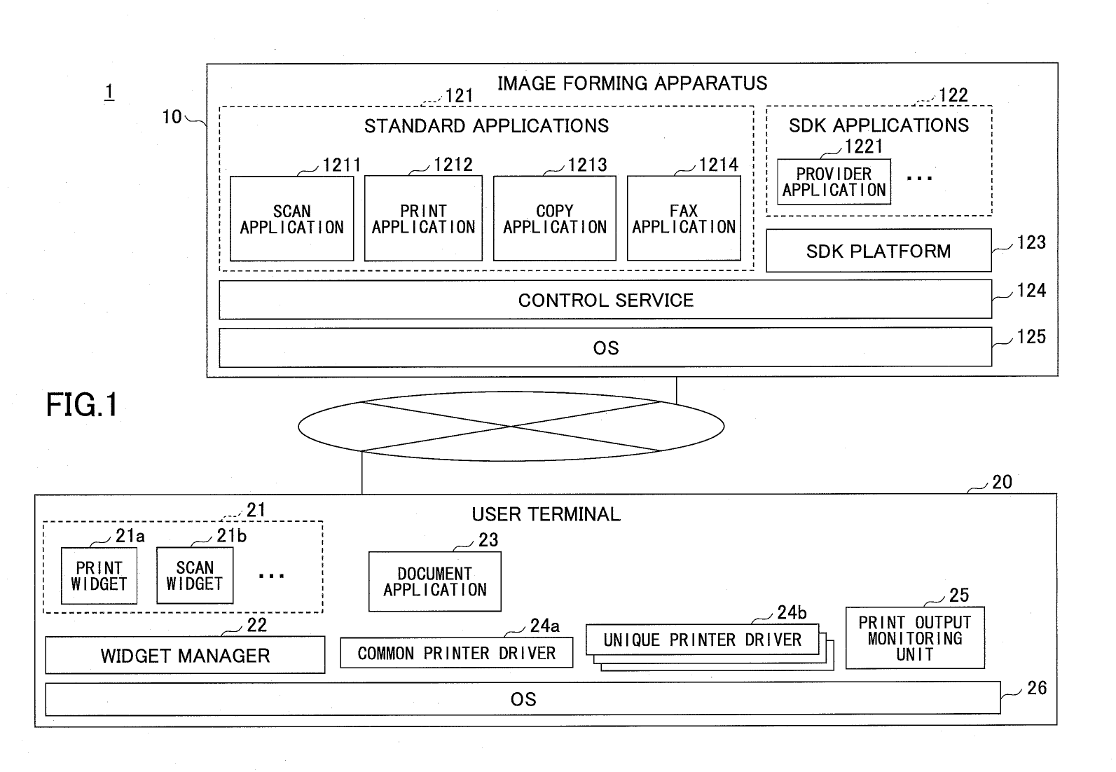

FIG. 1 illustrates an information processing system according to an embodiment of the present invention. An information processing system 1 shown in FIG. 1 includes one or more image forming apparatuses 10 and one or more user terminals 20, which are connected via a network (wired or wireless) such as a LAN (Local Area Network) or the Internet.

The image forming apparatus 10 is, for example, a multifunction peripheral in which two or more functions among scanning, printing, copying, and fax communication are implemented in a single housing. However, the image forming apparatus 10 may be a scanner, a printer, a copier, or a fax machine that has only one function.

The user terminal 20 is a terminal used by a user. The user terminal 20 is not limited to a particular device as long as software programs can be installed and executed, and a communication function is included. Examples of the user terminal 20 are a desktop PC (Personal Computer), a notebook PC, a PDA (Personal Digital Assistance), and a mobile phone.

A description is given of a software configuration of the user terminal 20. As shown in FIG. 1, the user terminal 20 includes a print widget 21a, a scan widget 21b, a widget manager 22, a document application 23, a common printer driver 24a, a unique printer driver 24b, a print output monitoring unit 25, and an OS 26.

The print widget 21a and the scan widget 21b is an application program that may be collectively referred to as a “widget 21”. In recent years, simple and convenient applications referred to as widgets or gadgets are available in the market. In the present embodiment, the widgets 21 generally refer to applications that can be easily and conveniently installed and used (thus, the technical scope is not limited by the term “widget”). In the present embodiment, the widgets 21 have a common characteristic in that they use functions of the image forming apparatus 10 (cooperate with the image forming apparatus 10) to implement a predetermined process flow (for example, a sequence of a process flow such as a workflow).

The print widget 21a causes the image forming apparatus 10 to execute a print job on print data that is generated for a predetermined logical printer.

The scan widget 21b causes the image forming apparatus 10 to execute scanning, and saves the scanned image data in the user terminal 20.

The widget manager 22 mediates communications between the widgets 21 and the image forming apparatus 10. Each of the widgets 21 need to be provided with an interface and a processing procedure specified by the widget manager 22. That is to say, the widgets 21 according the present embodiment are applications that operate in collaboration with the widget manager 22. The widget manager 22 does not need to be provided in each user terminal 20. For example, the widget manager 22 may be provided in a computer other than the user terminals 20. In this case, the widget manager 22 is shared by the widgets 21 of the user terminals 20.

The document application 23 is for creating electronic document data that may be a print object, such as word processor software and spreadsheet software. In FIG. 1, the document application 23 is expressed as a single block. However, there may be plural types of document applications 23 according to the data formats of document data.

The common printer driver 24a is a general-purpose printer driver that is compatible with (that can handle) image forming apparatuses 10 of various machine types. That is to say, the common printer driver 24a generates general-purpose print data that can be interpreted by various machine types, for document data generated by various document applications 23. However, not all machine types may be able to interpret (process) the print data generated by the common printer driver 24a.

Each of the unique printer drivers 24b is for handling an image forming apparatus 10 of a particular machine type. That is to say, the unique printer driver 24b generates print data that can be interpreted by a particular machine type, for document data generated by various document applications 23. Thus, the unique printer drivers 24b corresponding to the image forming apparatuses 10 of different machine types are installed in the user terminal 20.

In the user terminal 20, a logical printer corresponding to the print widget 21a is set for the common printer driver 24a and the respective unique printer drivers 24b. When a logical printer is specified as the print output destination, the common printer driver 24a or the unique printer driver 24b corresponding to the specified logical printer generates an intermediate file of a predetermined file name set as an output destination with respect to the logical printer, and outputs the print data to the intermediate file. In the following, when there is no need to distinguish between the common printer driver 24a and the unique printer driver 24b, they are collectively referred to as a “printer driver 24”.

The print output monitoring unit 25 monitors the intermediate files generated by the printer driver 24. When the print output monitoring unit 25 detects that an intermediate file has been generated, the print output monitoring unit 25 inputs the intermediate file in the print widget 21a. The print output monitoring unit 25 may be part of the print widget 21a.

The OS 26 is a typical operating system. Software items in the user terminal 20 operate as processes or threads on the OS 26.

A description is given of a software configuration of the image forming apparatus 10. As shown in FIG. 1, the image forming apparatus 10 includes standard applications 121, SDK applications 122, an SDK platform 123, a control service 124, and an OS 125.

The standard applications 121 are an assembly of applications that are pre-installed in the image forming apparatus 10 as standard equipment (the image forming apparatus 10 is shipped with the standard applications 121). In FIG. 1, the examples of the standard applications 121 are a scan application 1211, a print application 1212, a copy application 1213, and a fax application 1214. The scan application 1211 executes a scan job. The print application 1212 executes a print job. The copy application 1213 executes a copy job. The fax application 1214 executes a fax transmission job or a fax reception job.

The control service 124 is a group of software modules for providing functions for controlling various hardware resources with respect to upper level applications. For example, the control service 124 has a function relevant to network communications, a function for controlling the scanner, a function for controlling the printer, and a function for managing memories.

The SDK applications 122 are additionally installed in the image forming apparatus 10 after shipment, as plug-ins for expanding functions of the image forming apparatus 10. In FIG. 1, a provider application 1221 is illustrated as an example of the SDK application 122. The provider application 1221 executes a process for making the widget 21 operable by the image forming apparatus 10.

The SDK platform 123 provides an environment for executing the SDK applications 122. The SDK applications 122 are developed with the use of an API (Application Program Interface) provided by the SDK platform 123. For example, the SDK platform 123 provides the SDK applications 122 with an interface for using a scanning function, an interface for using a printing function, and an interface for using the copy function. The API of the SDK applications 122 is available to the public, and a third party vendor may develop the SDK application 122.

The OS 125 is a typical operating system. Software items in the image forming apparatus 10 operate as processes or threads on the OS 125.

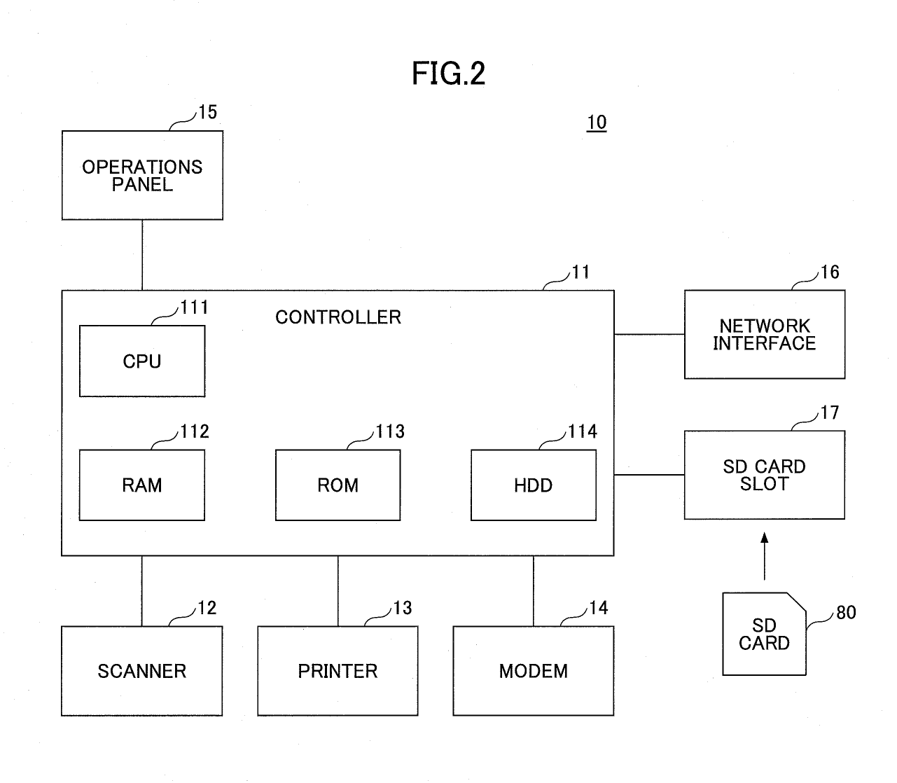

Next, a description is given of hardware configurations of the respective devices. FIG. 2 illustrates a hardware configuration of the image forming apparatus 10 according to an embodiment of the present invention. As shown in FIG. 2, the image forming apparatus 10 includes hardware elements such as a controller 11, a scanner 12, a printer 13, a modem 14, an operations panel 15, a network interface 16, and an SD card slot 17.

The controller 11 includes a CPU 111, a RAM 112, a ROM 113, and a HDD 114. The ROM 113 records various programs and data used by the programs. The RAM 112 is used as a storage area for loading programs and a work area for the loaded programs. The CPU 111 processes the programs loaded in the RAM 112 to implement various functions. The HDD 114 records programs and various data items used by the programs.

The scanner 12 is a hardware element for scanning an original to obtain image data. The printer 13 is a hardware element for printing data onto a sheet. The modem 14 is a hardware element for connecting the image forming apparatus 10 to a telephone line to transmit and receive image data by fax communications. The operations panel 15 is a hardware element including an input unit such as buttons for receiving input from a user, and a display unit such as a liquid crystal panel. The network interface 16 is a hardware element for connecting the image forming apparatus 10 to a network (wired or wireless) such as LAN. The SD card slot 17 is used for reading programs recorded in an SD card 80. In the image forming apparatus 10, in addition to programs recorded in the ROM 113, programs recorded in the SD card 80 may also be loaded and executed in the RAM 112. The SD card 80 may be replaced by another recording medium (for example, a CD-ROM or a USB (Universal Serial Bus)). That is to say, the type of recording medium corresponding to the SD card 80 is not limited to a particular type of medium. In this case, the SD card slot 17 may be replaced by a hardware element according to the type of recording medium.

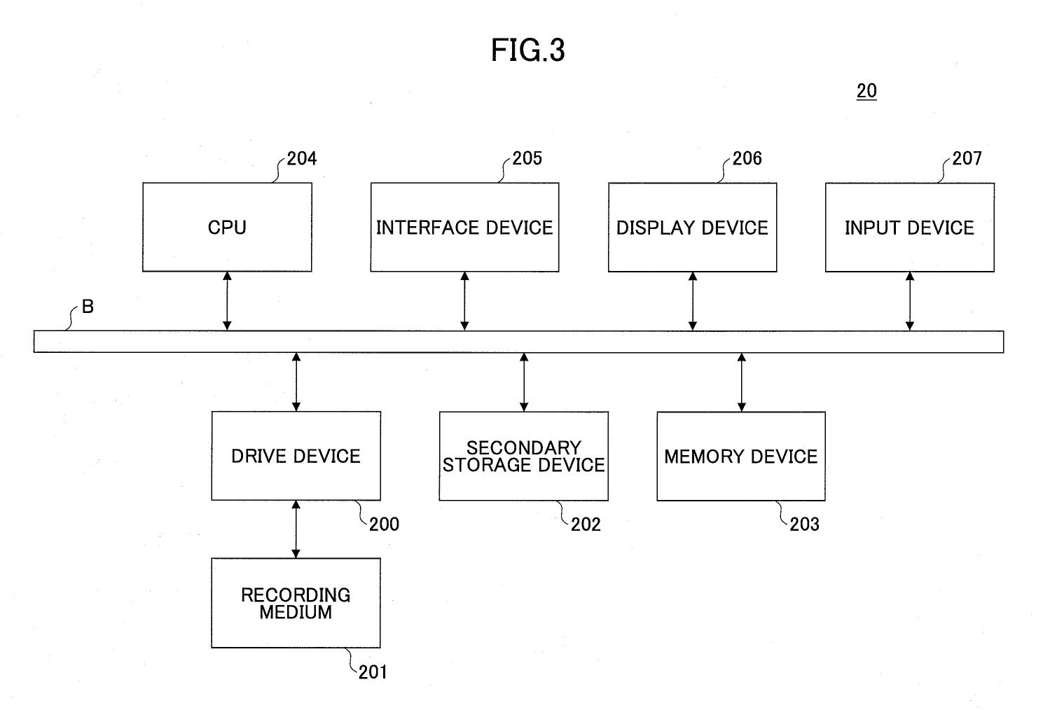

FIG. 3 is a hardware configuration of the user terminal 20 according to an embodiment of the present invention. The user terminal 20 shown in FIG. 3 includes a drive device 200, a secondary storage device 202, a memory device 203, a CPU 204, an interface device 205, a display device 206, and an input device 207, which are interconnected by a bus B.

Programs for implementing processes at the user terminal 20 are provided by a recording medium 201 such as a CD-ROM and a memory card. When the recording medium 201 recording a program is set in the drive device 200, the program is installed in the secondary storage device 202 via the drive device 200, from the recording medium 201. However, the program need not be installed from the recording medium 201 and the program may be downloaded from another computer via a network. The secondary storage device 202 stores the installed program as well as necessary files and data.

The memory device 203 reads a program from the secondary storage device 202 and stores the read program, when an instruction to activate the program is received. The CPU 204 implements functions of the user terminal 20 according to the program stored in the memory device 203. The interface device 205 is used for performing various types of communications. For example, the interface device 205 may be an interface for connecting to a network, an interface for connecting to USB (Universal Serial Bus), and an interface for performing wireless communication such as Bluetooth. The display device 206 displays a GUI (Graphical User Interface) according to a program. The input device 207 includes a keyboard, a pointing device such as a mouse, and buttons, and is used for inputting various operation instructions.

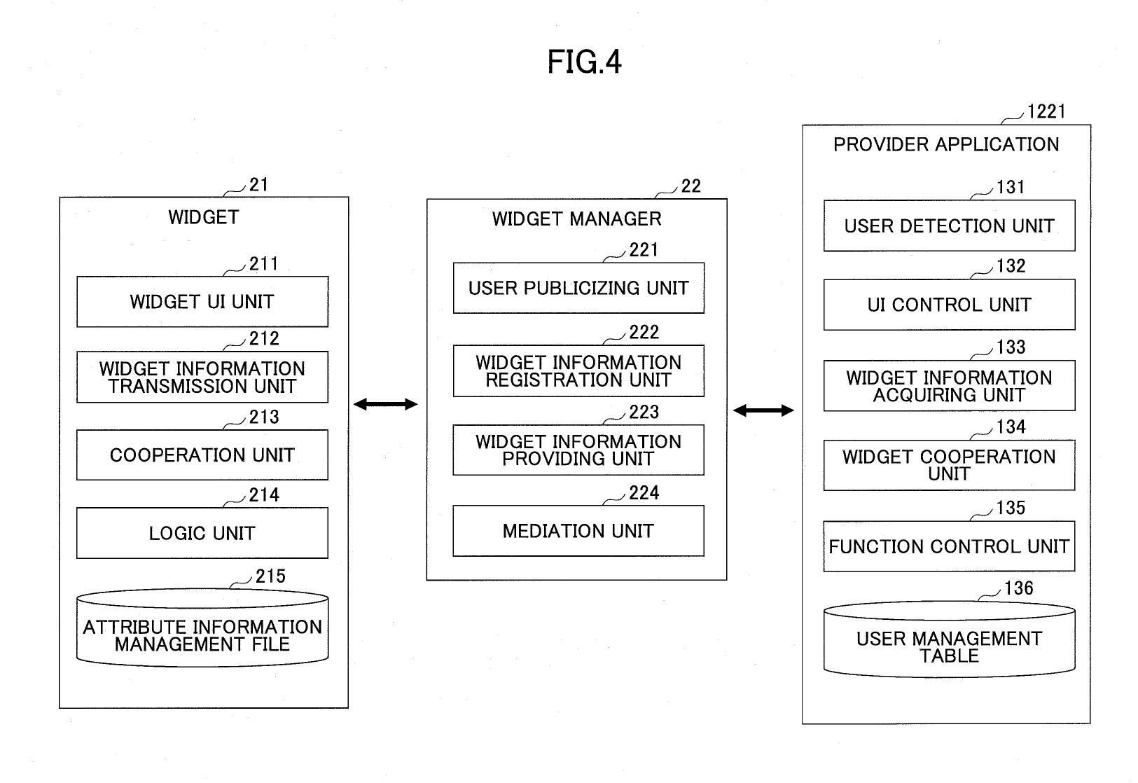

Next, detailed descriptions are given of the widget 21, the widget manager 22, and the provider application 1221. FIG. 4 illustrates a functional configuration of the widget 21, the widget manager 22, and the provider application 1221.

As shown in FIG. 4, each widget 21 includes a widget UI unit 211, a widget information transmission unit 212, a cooperation unit 213, a logic unit 214, and an attribute information management file 215.

The widget UI unit 211 performs various display control operations and input control operations relevant to the widget 21. The widget information transmission unit 212 sends, to the widget manager 22, a request to register widget information (attribute information of the widget 21), when the widget 21 is activated. Widget information includes identification information (hereinafter, “cooperation function identifier”) relevant to a function (hereinafter, “cooperation function”) of the image forming apparatus 10 used by the widget 21. The cooperation function is a function that the image forming apparatus 10 cooperating with the widget 21 is required to have.

The cooperation unit 213 controls communications (exchange of information) for cooperating with the provider application 1221. The attribute information management file 215 is a file for storing attribute information regarding the widget 21. The attribute information includes setting information regarding the widget 21. The setting information is an assembly of parameters defining operations of the widget 21 or contents of a job to be executed by the widget 21. The logic unit 214 is where a function unique to the widget 21 is installed. For example, the logic unit 214 of the print widget 21a executes a process for causing the image forming apparatus 10 to execute a print job for print data generated for a predetermined logical printer. The logic unit 214 of the scan widget 21b executes a process of saving image data obtained by a scanning operation.

In the following description, in order to distinguish units belonging to the print widget 21a between units belonging to the scan widget 21b, the units belonging to the print widget 21a are denoted by a reference numeral accompanied by an “a”, and the units belonging to the scan widget 21b are accompanied by a “b”. For example, the logic unit 214 of the print widget 21a is expressed as “logic unit 214a”.

The widget manager 22 includes a user publicizing unit 221, a widget information registration unit 222, a widget information providing unit 223, and a mediation unit 224.

The user publicizing unit 221 publicizes (broadcasts or multicasts), in the network, the user ID of the user that has logged into the user terminal 20, when the widget manager 22 is activated. The publication is issued in units of users (in units of user IDs). Therefore, the publication (hereinafter, “user publication”) issued by the user publicizing unit 221 is information for reporting to the image forming apparatus 10 that there is a new user that can use one of the widgets 21.

The widget information registration unit 222 receives a request to register the widget information sent from the widget 21, and saves the widget information in, for example, the secondary storage device 202.

The widget information providing unit 223 provides (sends) the widget information saved in the secondary storage device 202 to the image forming apparatus 10, in response to a request form the image forming apparatus 10. The mediation unit 224 mediates or relays the communications between the widget 21 and the provider application 1221.

The provider application 1221 includes a user detection unit 131, a UI control unit 132, a widget information acquiring unit 133, a widget cooperation unit 134, a function control unit 135, and a user management table 136.

The user detection unit 131 detects that there is a user (user terminal 20) that can use the widget 21, based on the user publication issued by the widget manager 22. Then, the user detection unit 131 registers, into the user management table 136, the user ID included in the user publication. The user management table 136 is for managing a list of users present in the network who can use the widget 21, and is stored in, for example, the HDD 114.

The UI control unit 132 receives input of an instruction to operate the widget 21 from a user.

That is to say, the widget 21 is located in the user terminal 20, but the widget 21 can be operated from the operations panel 15 of the image forming apparatus 10.

The widget information acquiring unit 133 acquires, from the widget manager 22, widget information of the widget 21 belonging to the user who is selected among users registered in the user management table 136. The widget cooperation unit 134 controls communications with the widget manager 22. The function control unit 135 controls the operation of executing functions requested by the widgets 21. The processes of implementing the functions are delegated to the standard applications 121 and other SDK applications 122.

Hereinafter, a description is given of processing procedures of the information processing system 1. Before using the widget 21, the user activates the widget manager 22 at the user terminal 20, and then activates the widget 21 that the user intends to use. First, a description is given of processing procedures performed when the widget manager 22 and the widget 21 are activated.

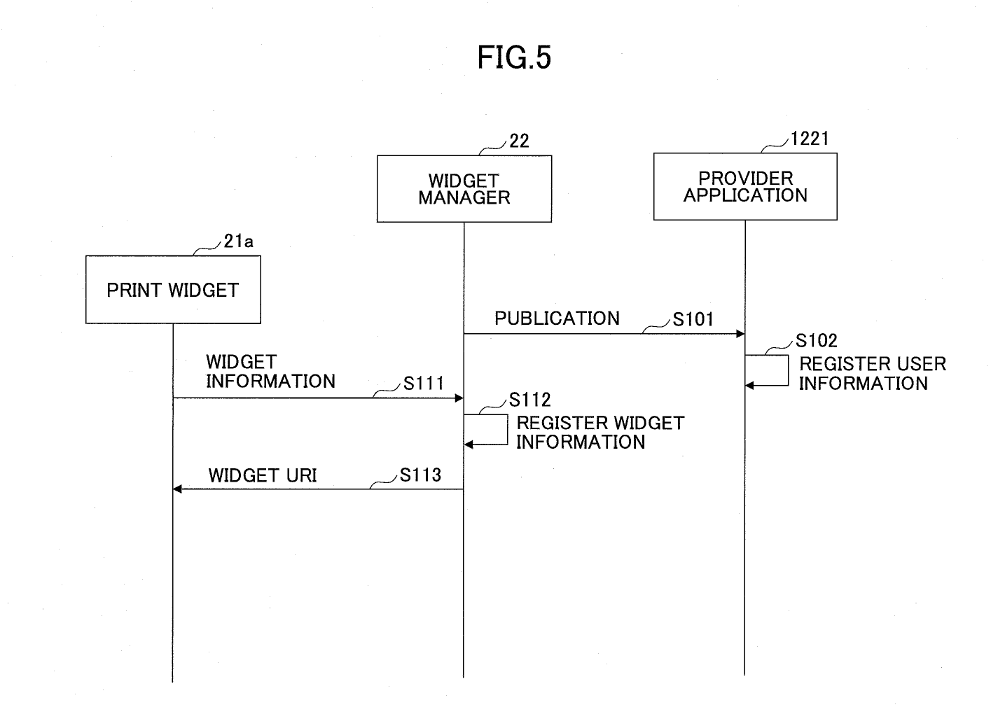

FIG. 5 is a sequence diagram for describing the processing procedures performed when the widget manager 22 and the print widget 21a are activated.

The widget manager 22 is activated in response to a user's instruction or automatically. The user publicizing unit 221 of the widget manager 22 sends, to the network, a user publication including the user ID of the user who has logged in and a widget manager URI (Uniform Resource Identifier) (step S101).

Next, upon receiving the user publication, the user detection unit 131 of the provider application 1221 of each image forming apparatus 10 registers, in the user management table 136, the user ID and the widget manager URI included in the user publication (step S102).

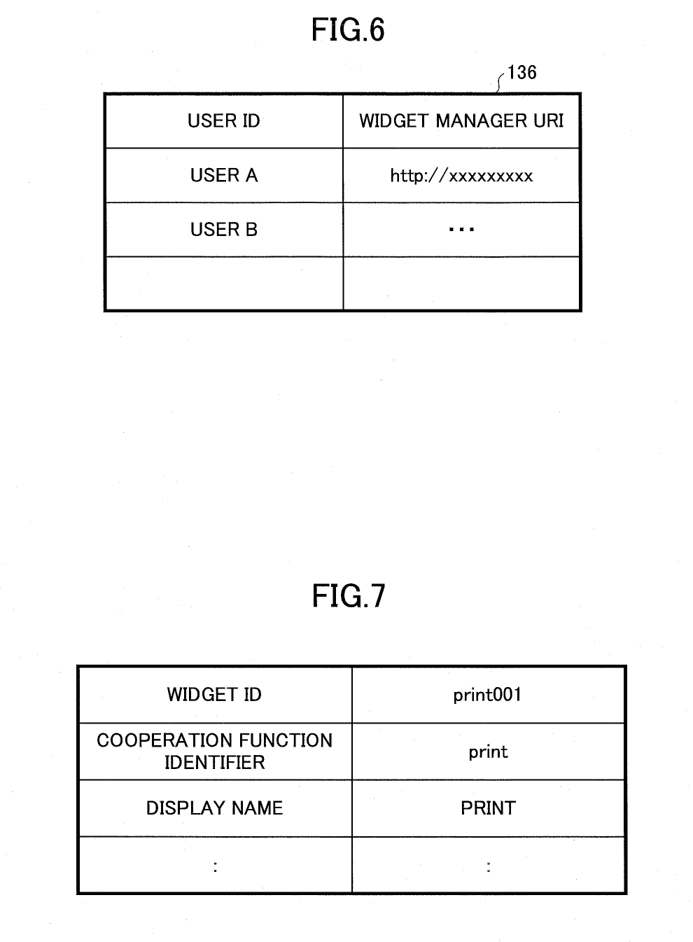

FIG. 6 illustrates an example of the user management table 136. As shown in FIG. 6, the user management table 136 stores the user IDs and the widget manager URIs in association with each other. The widget manager URI is a URI that is unique to each widget manager 22. In the present embodiment, one widget manager 22 is activated for each user terminal 20. Thus, the widget manager URI corresponds to identification information of the user terminal 20.

When multiple users activate the widget mangers 22 at their respective user terminals 20, records corresponding to the multiple users are registered in the user management tables 136 at the respective image forming apparatuses 10.

After the widget manager 22 has been activated, the user activates the print widget 21a or the scan widget 21b at the user terminal 20. In this example, a description is given of a case where the print widget 21a is activated.

When the print widget 21a is activated, the widget information transmission unit 212a of the print widget 21a sends, to the widget manager 22, a request to register the widget information of the print widget 21a (step S111).

FIG. 7 illustrates an example of widget information of the print widget 21a. In FIG. 7, the widget information of the print widget 21a includes a widget ID, a cooperation function identifier, and a display name.

The widget ID is identification information for uniquely identifying each widget 21. The coordination function identifier corresponds to the print widget 21a. The print widget 21a is a widget 21 that causes the image forming apparatus 10 to execute printing. That is to say, the print widget 21a uses the print function of the image forming apparatus 10. Accordingly, the cooperation function identifier of the print widget 21a is “print”, which expresses the print function. The display name is a character string for displaying the name of the print widget 21a. For example, the widget information is acquired from the attribute information management file 215a.

The widget information sent from the widget information transmission unit 212a of the print widget 21a is received by the widget information registration unit 222 of the widget manager 22. The widget information registration unit 222 generates a URI including the widget ID included in the received widget information, and saves (registers) the widget information in the secondary storage device 202 in association with the corresponding URI (step S112). A URI is generated for each widget when the widget information is registered. Hereinafter, such a URI is referred to as a “widget URI”. The widget URI is generated by attaching a widget ID to the end of the widget manager URI. A different widget manager URI is given to each widget manager 22 (i.e., each user terminal 20). Thus, even when the same print widget 21a is activated at different user terminals 20, the widget URIs of the respective print widgets 21a are different. That is to say, it is possible to identify a single print widget 21a in the network, based on the widget URI.

Next, the widget information registration unit 222 returns the widget URI generated at step S112, to the widget information transmission unit 212a of the print widget 21a (step S113). The widget information transmission unit 212a records, in the memory device 203, the returned widget URI as the widget URI corresponding to the print widget 21a. Furthermore, the widget UI unit 211a of the activated print widget 21a causes the display device 206 of the user terminal 20 to display an icon corresponding to the widget 21a.

As described above, the print widget 21a is registered in the widget manager 22.

FIG. 5 is used to describe the print widget 21a, but the same processing procedures as those of FIG. 5 are executed when the scan widget 21b is activated. For example, in step S111, the widget information transmission unit 212b of the activated scan widget 21b sends the widget information of the scan widget 21b to the widget manager 22.

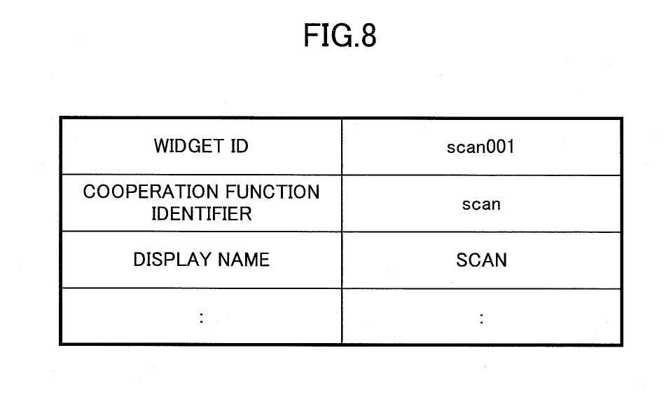

FIG. 8 illustrates an example of widget information of the scan widget 21b. The items constituting the widget information of FIG. 8 are the same as those constituting the print widget 21a described with reference to FIG. 7; however, the values of the items are different.

That is to say, the widget ID corresponds to the scan widget 21b. Furthermore, the scan widget 21b uses the scanning function of the image forming apparatus 10. Therefore, the cooperation function identifier of the scan widget 21b is “scan”, which expresses the scanning function. The display name is a character string for displaying the name of the scan widget 21b.

In response to receiving widget information shown in FIG. 8, the widget manager 22 generates a widget URI corresponding to the scan widget 21b, and the generated widget URI is returned to the scan widget 21b.

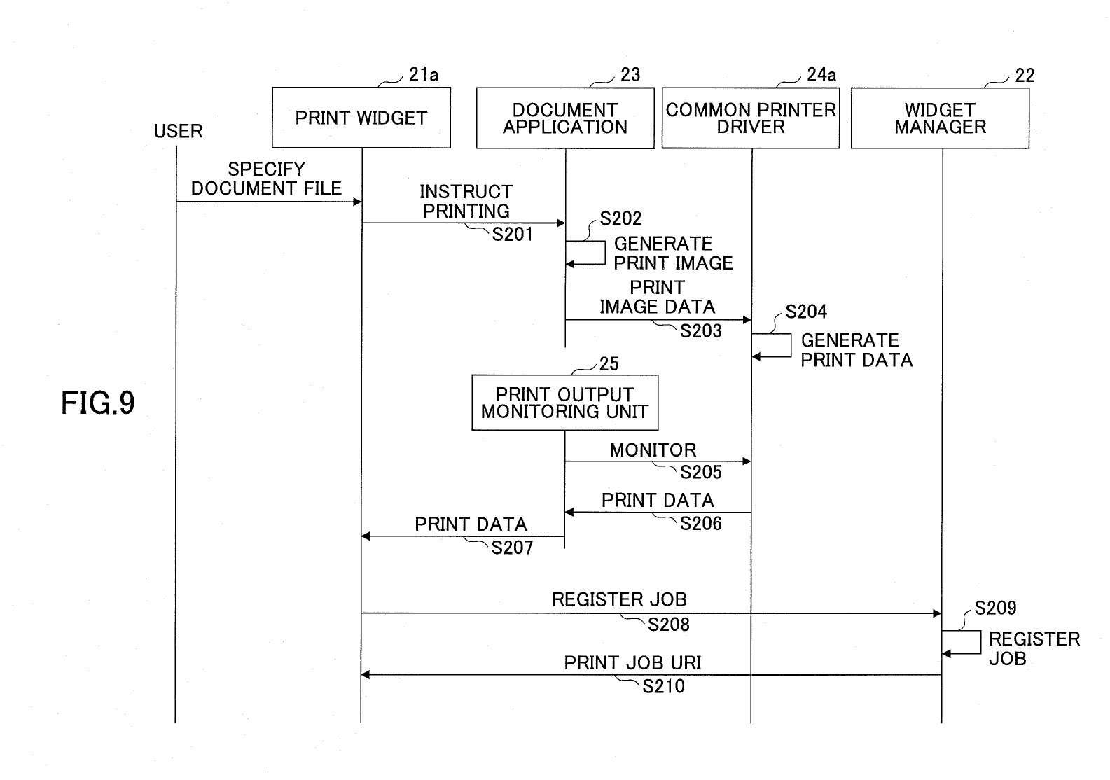

Next, a description is given of a process of registering a print job performed by the print widget 21a, according to a first embodiment. FIG. 9 is a sequence diagram of processing procedures for registering a print job performed by the print widget 21a according to the first embodiment.

For example, when an icon of a document file that is a print object is dragged and dropped into an icon of the print widget 21a, the logic unit 214a of the print widget 21a inputs a printing instruction to the document application 23 corresponding to the document file relevant to the file icon that has been dropped (step S201). The document application 23 corresponding to the document file means the document application 23 corresponding to the type of the document file. For example, the print widget 21a uses the secondary storage device 202 to manage association information associating the type of the document file (for example, the extension of the document file) with the name of the document application 23. The print widget 21a determines the document application 23 corresponding to the document file relevant to the icon that has been dropped, based on the association information.

The print instruction for the document application 23 is implemented by inputting, into the OS 26, a command line indicating the print instruction for the document application 23, in which the document file name of the document file relevant to the dropped icon is specified as the argument. Furthermore, in the print instruction, the logical printer name that is the print output destination is specified. In this example, the name of the logical printer, which corresponds to the common printer driver 24a and is set for the print widget 21a, is specified in the print instruction.

In response to the command line being input to the OS 26, the document application 23 is activated in the background. The document application 23 generates a print image of a specified document file (step S202). Next, the document application 23 inputs the print request for the print image into the common printer driver 24a relevant to the logical printer specified in the print instruction (step S203).

In response to the print request, the common printer driver 24a generates print data (PDL (Page Description Language)) relevant to the document data. The common printer driver 24a generates an intermediate file having a predetermined file name set as the output destination for the logical printer, and outputs the print data to the intermediate file (step S204).

Meanwhile, the print output monitoring unit 25 monitors the generated intermediate files having a predetermined file name (step S205). Specifically, the print output monitoring unit 25 polls files having a predetermined file name in a predetermined folder, to confirm whether there is an intermediate file. When the print output monitoring unit 25 detects that an intermediate file has been generated, the print output monitoring unit 25 reads print data from the intermediate file (step S206). The print output monitoring unit 25 inputs the print data in the print widget 21a (step S207).

Next, the cooperation unit 213a of the print widget 21a sends, to the widget manager 22, a request to register a print job relevant to the print data (step S208). In the request to register the print job, the widget URI for the print widget 21a is also specified.

The request to register the print job sent from the cooperation unit 213a of the print widget 21a in step S208 is received by the widget information registration unit 222 of the widget manager 22. The widget information registration unit 222 generates a URI (print job URI) for identifying the print job relevant to the registration request, based on the widget URI specified in the received registration request. Then, the widget information registration unit 222 records the print job in the secondary storage device 202, in association with the generated print job URI (step S209). The print job URI is generated by attaching an identifier of each print job to the end of the widget URI. The widget information registration unit 222 returns the generated print job URI to the cooperation unit 213a of the print widget 21a (step S210).

Subsequently, when an icon of a document file is dropped into the icon of the print widget 21a, the print job relevant to the document file is registered in the widget manager 22. That is to say, in each widget manager 22, plural print jobs relevant to one print widget 21a may be stored. In this case, the widget manager 22 generates plural print job URIs based on a single widget URI, and the print jobs are stored in association with the respective print job URIs.

After registering the print job in the widget manager 22 via the print widget 21a, the user moves to the location where the image forming apparatus 10 is installed, to execute the print job. When plural image forming apparatuses 10 are connected to the network, the same user publication is received by the respective image forming apparatuses 10, and the contents of the user publication are registered in the user management tables 136 of the respective image forming apparatuses 10. Thus, the user can cause any of the plural image forming apparatuses 10 to execute the print job, as long as the image forming apparatus 10 has a printing function.

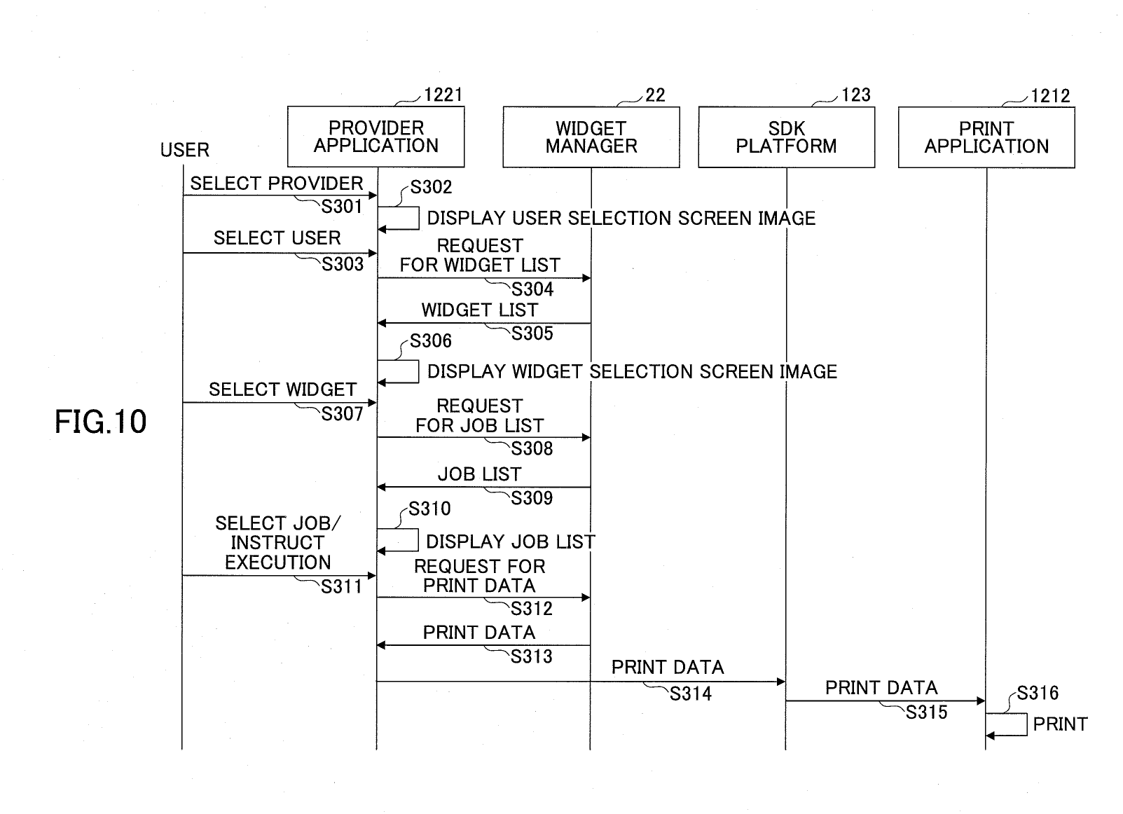

Next, a description is given of a process that is executed in response to user operation at the image forming apparatus 10. FIG. 10 is a sequence diagram for describing the processing procedures when a print job is executed according to the first embodiment.

When a user selects the provider application 1221 as the usage object, via the operations panel 15 of the image forming apparatus 10 that is the operation object (i.e., the output destination) (step

S301), the UI control unit 132 of the provider application 1221 causes the operations panel 15 to display a user selection screen image, based on the information registered in the user management table 136 (step S302).

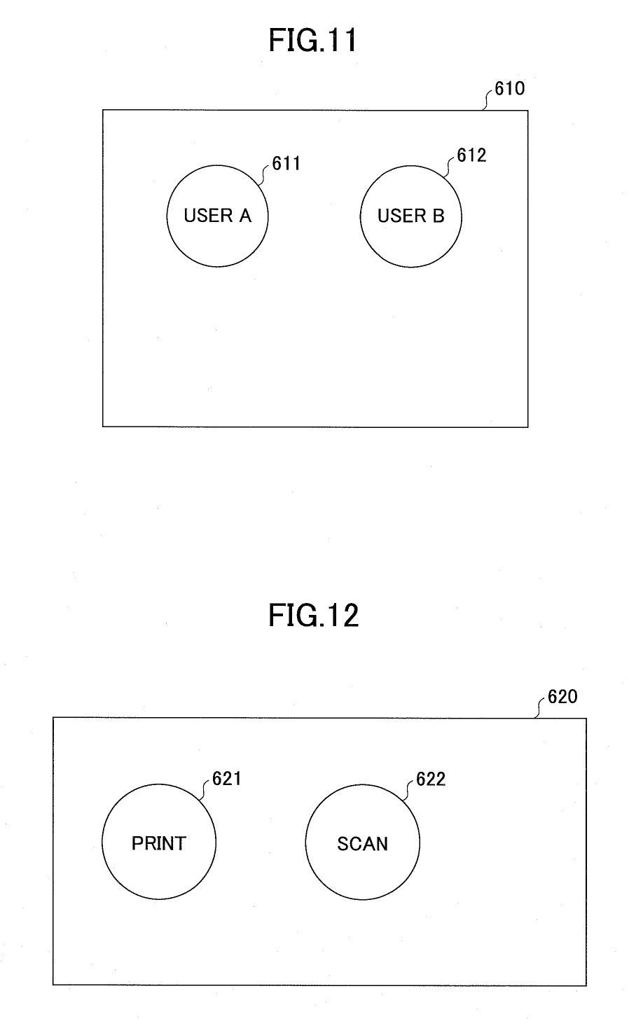

FIG. 11 illustrates a display example of a user selection screen image. A user selection screen image 610 shown in FIG. 11 displays buttons for the respective user IDs. In FIG. 11, a button 611 corresponding to a user A and a button 612 corresponding to a user B are displayed.

Next, the user presses the button corresponding to his user ID in the user selection screen image 610 (step S303). As the button is pressed, the widget information acquiring unit 133 acquires, from the user management table 136, a widget manager URI associated with the user ID corresponding to the selected button.

Next, the widget information acquiring unit 133 sends, to the widget manager 22 relevant to the acquired widget manger URI, a request to acquire a list of widget information items (widget list) (step S304). The request to acquire the widget list is received by the widget information providing unit 223 of the widget manager 22. The widget information providing unit 223 acquires a list of widget information items recorded in the secondary storage device 202, and returns the list (i.e., the widget list) to the provider application 1221 (step S305). In the widget list transferred to the provider application 1221, the widget information has attached a widget URI assigned to the widget relevant to the widget information.

Next, the UI control unit 132 of the provider application 1221 records the received widget list in the RAM 112, and causes the operations panel 15 to display the screen image (widget selection screen image) including the list of widgets 21 that can be used by the user, based on the widget list (step S306).

FIG. 12 illustrates a display example of a widget selection screen image. A widget selection screen image 620 shown in FIG. 12 displays a button 621 corresponding to the print widget 21a and a button 622 corresponding to the scan widget 21b. That is to say, FIG. 12 is a display example of the widget selection screen image 620 when a widget list including widget information of the print widget 21a and widget information of the scan widget 21b, is received in step S305.

When the button 621 is pressed in the widget selection screen image 620 (step S307), the widget cooperation unit 134 determines that a print job is to be executed, based on the cooperation function identifier (“print”) included in the widget information relevant to the selected button 621. The widget cooperation unit 134 specifies a widget URI associated with the widget information, and sends, to the widget manager 22 relevant to the widget URI, a request to acquire list information of print jobs (job list) (step S308).

The acquisition request is received by the mediation unit 224 of the widget manager 22. The mediation unit 224 generates a job list including print job URIs and job names for the respective print jobs recorded in the secondary storage device 202 in association with the widget URI specified in the acquisition request, and returns the job list to the widget cooperation unit 134 (step S309). A job name is, for example, a document file name that is a printing object in the print job.

When the widget cooperation unit 134 of the provider application 1221 receives the job list, the widget cooperation unit 134 causes the operations panel 15 to display a list of job names included in the job list (step S310). When the user selects a job name that is an execution object from the list (step S311), the widget cooperation unit 134 specifies the print job URI corresponding to the selected job name, and sends, to the widget manager 22 relevant to the print job URI, a request to acquire print data relevant to the print job (step S312).

The acquisition request is received by the mediation unit 224 of the widget manager 22. The mediation unit 224 acquires, from the secondary storage device 202, print data (print job) recorded in the secondary storage device 202 in association with the print job URI specified in the acquisition request, and returns the print data to the provider application 1221 (step S313).

The widget cooperation unit 134 of the provider application 1221 inputs the received print data in the function control unit 135. Then, the function control unit 135 inputs the print data in the print application 1212, via the SDK platform 123 (steps 5314 and S315). The print application 1212 controls the printer 13 based on the print data, and causes the printer 13 to execute printing of the print data (step S316). When the print application 1212 of the image forming apparatus 10, or a lower level program module used by the print application 1212 (for example, a program module included in the control service 124), can process the print data generated by the common printer driver 24a, the print process can be successfully performed.

Meanwhile, when the print application 1212 of the image forming apparatus 10, or a lower level program module used by the print application 1212 cannot handle the print data generated by the common printer driver 24a, the print process becomes unsuccessful.

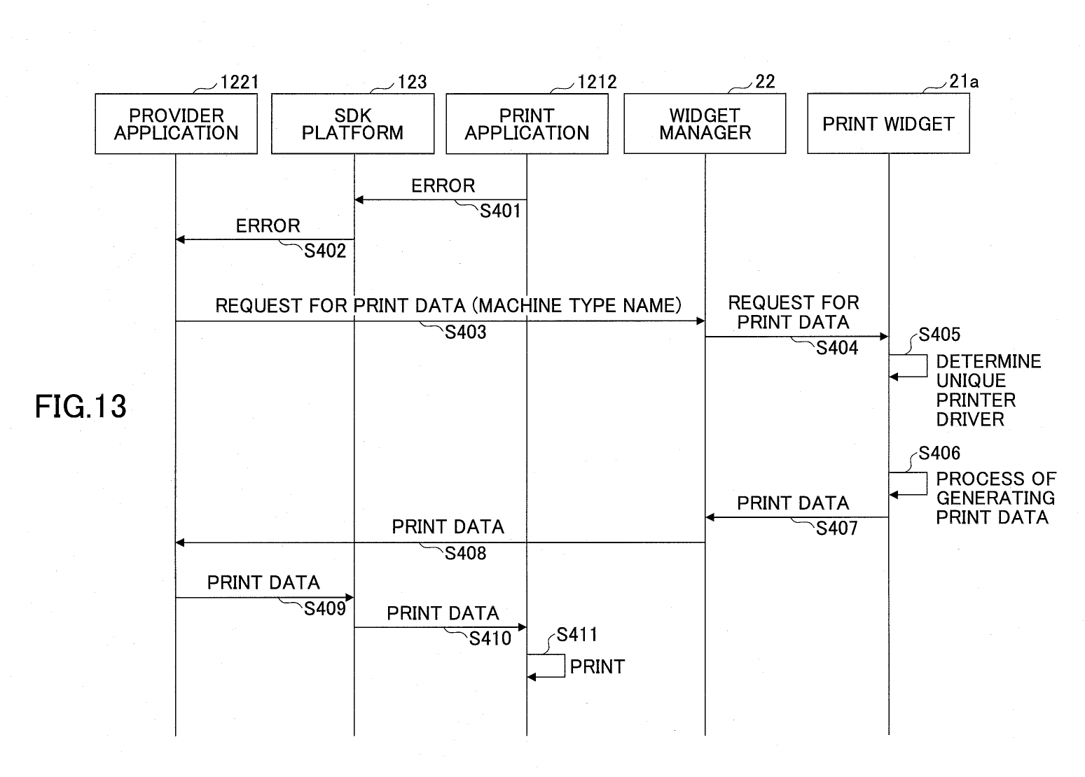

FIG. 13 is a sequence diagram for describing the processing procedures executed when the image forming apparatus that is the output destination is not handled by the common printer driver 24a according to the first embodiment.

In step S316 of FIG. 10, when the print process executed by the print application 1212 is unsuccessful, error information indicating the print process was unsuccessful is reported to the provider application 1221 via the SDK platform 123 (steps 5401 and S402). When the content of the error indicates that the print data is in a format that cannot be handled (cannot be processed) (i.e., the image forming apparatus 10 cannot be handled by the common printer driver 24a), the provider application 1221 specifies a print job URI corresponding to the job name selected at step S311 in FIG. 10, and once again sends, to the widget manager 22 relevant to the print job URI, a request to acquire the print data relevant to the print job (step S403). However, in the request to acquire print data given at step S403, the machine type name (model name) of the image forming apparatus 10 is attached. The machine type name is acquired from, for example, the ROM 113 or the HDD 114 of the image forming apparatus 10.

The provider application 1221 may determine whether the image forming apparatus 10 can be handled by the common printer driver 24a. For example, the HDD 114 of each image forming apparatus 10 may store a list of machine types that can be handled by the common printer driver 24a. The function control unit 135 of the provider application 1221 determines the printer driver 24 that generated the print data, before inputting the print data in the print application 1212 via the SDK platform 123, at step S314 in FIG. 10. The printer driver 24 that is the generation source of the print data can be determined by referring to header information in the print data. When the generation source of the print data is the common printer driver 24a, the function control unit 135 determines whether the image forming apparatus 10 can be handled by the printer driver 24, by crosschecking the machine type name of the image forming apparatus 10 with the list of machine type names that can be handled by the common printer driver 24a. That is to say, if the machine type name of the image forming apparatus 10 is included in the list, it is determined that the image forming apparatus 10 can be handled by the common printer driver 24a. Meanwhile, if the machine type name of the image forming apparatus 10 is not included in the list, it is determined that the image forming apparatus 10 cannot be handled by the common printer driver 24a.

When the function control unit 135 determines that the image forming apparatus 10 cannot be handled by the common printer driver 24a, the provider application 1221 executes step S403. Accordingly, in this case, steps S314 through S316 of FIG. 10 are not executed, and step S403 is executed instead.

The request to acquire print data sent in step S403 is received by the mediation unit 224 of the widget manager 22 to which the acquisition request is sent. In response to the machine type name specified in the acquisition request, the mediation unit 224 specifies the document file name of the print job associated with the print job URI specified in the acquisition request, and sends a request to generate print data to the print widget 21a relevant to the print job URI (step S404). In the generation request, there is specified the machine type name specified in the request to acquire the print data.

That is to say, when a machine type name is not specified in the request to acquire print data from the provider application 1221, the mediation unit 224 returns, to the provider application 1221, the print data recorded in the secondary storage device 202 in association with the print job URI specified in the acquisition request, as in step S313 of FIG. 10. Meanwhile, when a machine type name is specified in the acquisition request, the mediation unit 224 requests the print widget 21a relevant to the print job URI to generate new print data.

The logic unit 214a of the print widget 21a determines the unique printer driver 24b corresponding to (compatible with) the machine type name specified in the generation request, in response to receiving the request to generate print data (step S405). Usually, information indicating the machine type name, with which the unique printer driver 24b is compatible, is associated with the unique printer driver 24b. In the present embodiment, the name of each unique printer driver 24b includes the corresponding machine type name. Thus, the logic unit 214a determines the unique printer driver 24b, which has a name including the machine type name specified in the generation request, as a unique printer driver 24b that can handle (that is compatible with) the specified machine type. However, the information associating the unique printer drivers 24b with machine type names may be managed in a different format.

Next, the logic unit 214a activates the process of generating the print data (step S406). Contents of the process of generating print data at step S406 correspond to the processing procedures of steps S201 through S207 in FIG. 9. However, in a step corresponding to step S201, the logic unit 214a specifies a logical printer name that corresponds to the unique printer driver 24b determined at step S405 and that is set for the print widget 21a. Therefore, in the process of generating print data in step S406, print data is generated by the unique printer driver 24b.

Next, the cooperation unit 213a of the print widget 21a sends, to the widget manager 22, the generated print data, as a response to the request to generate print data given at step S404 (step S407). Next, the mediation unit 224 of the widget manager 22 sends, to the provider application 1221, the received print data as a response to the request to acquire print data given at step S403 (step S408).

Next, in steps 5409 through S411, the same processes as those of steps S314 through S316 of FIG. 10 are executed on the print data received by the provider application 1221 at step S408. However, the print data received at step S408 is generated by the unique printer driver 24b corresponding to (compatible with) the machine type of the image forming apparatus 10. Thus, in step S411, unless there is some abnormality in the image forming apparatus 10, the printing is likely to be successful.

In step S405, when the unique printer driver 24b corresponding to (compatible with) the machine type name is not installed in the user terminal 20, step S406 is not executed. Furthermore, in steps

S407 and S408, error information is transferred instead of print data. The UI control unit 132 of the provider application 1221 causes the operations panel 15 to display error information.

As described above, according to the first embodiment, even when an image forming apparatus 10 that cannot be handled by the common printer driver 24a is selected as the output destination of the print data (print job) generated by the common printer driver 24a and registered in the widget manager 22, print data is automatically generated once again by the unique printer driver 24b that can handle (that is compatible with) the machine type of the image forming apparatus 10. Therefore, it is possible to enhance the possibility of successfully printing out the print data registered in the widget manager 22, with the image forming apparatus 10 that is initially selected as the output destination.

Next, a description is given of a second embodiment. In the second embodiment, only the points that are different from those of the first embodiment are described. Therefore, the points that are not particularly mentioned may be the same as the first embodiment.

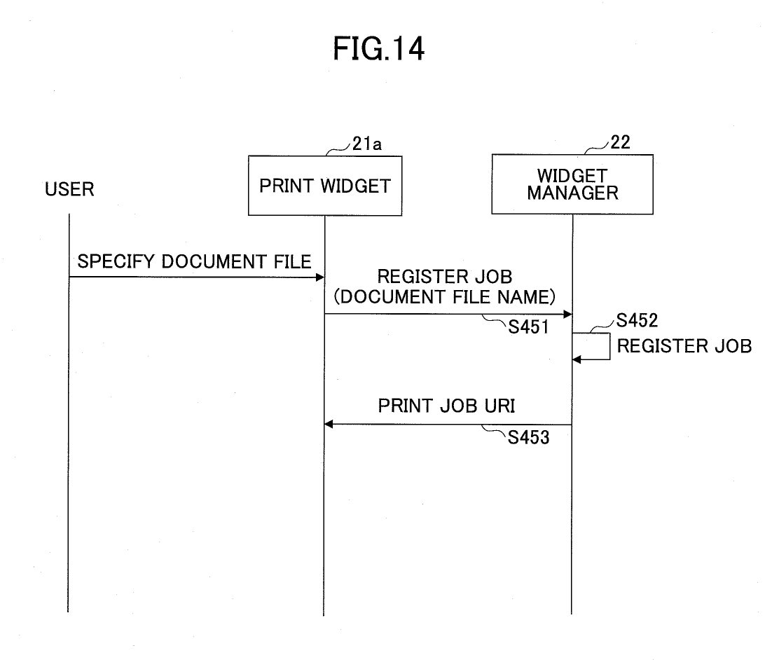

In the second embodiment, the process of FIG. 9 is replaced by the process of FIG. 14.

FIG. 14 is a sequence diagram of processing procedures for registering a print job performed by the print widget 21a, according to the second embodiment.

For example, when an icon of a document file that is a print object is dragged and dropped into an icon of the print widget 21a, the cooperation unit 213a of the print widget 21a specifies the file name of the document file that has been dropped into the widget URI of the print widget 21a, and sends a request to register a print job to the widget manager (step S451).

The request to register the print job sent from the cooperation unit 213a of the print widget 21a is received by the widget information registration unit 222 of the widget manager 22. The widget information registration unit 222 generates a print job URI for the print job relevant to the registration request, based on the widget URI specified in the received registration request. Then, the widget information registration unit 222 records the print job in the secondary storage device 202, in association with the generated print job URI (step S452). The widget information registration unit 222 returns the generated print job URI to the cooperation unit 213a of the print widget 21a (step S453).

The content of the print job registered in the widget manager 22 is a document file name, and not print data. That is to say, in the second embodiment, a print job that has an empty entity is registered in the widget manager 22.

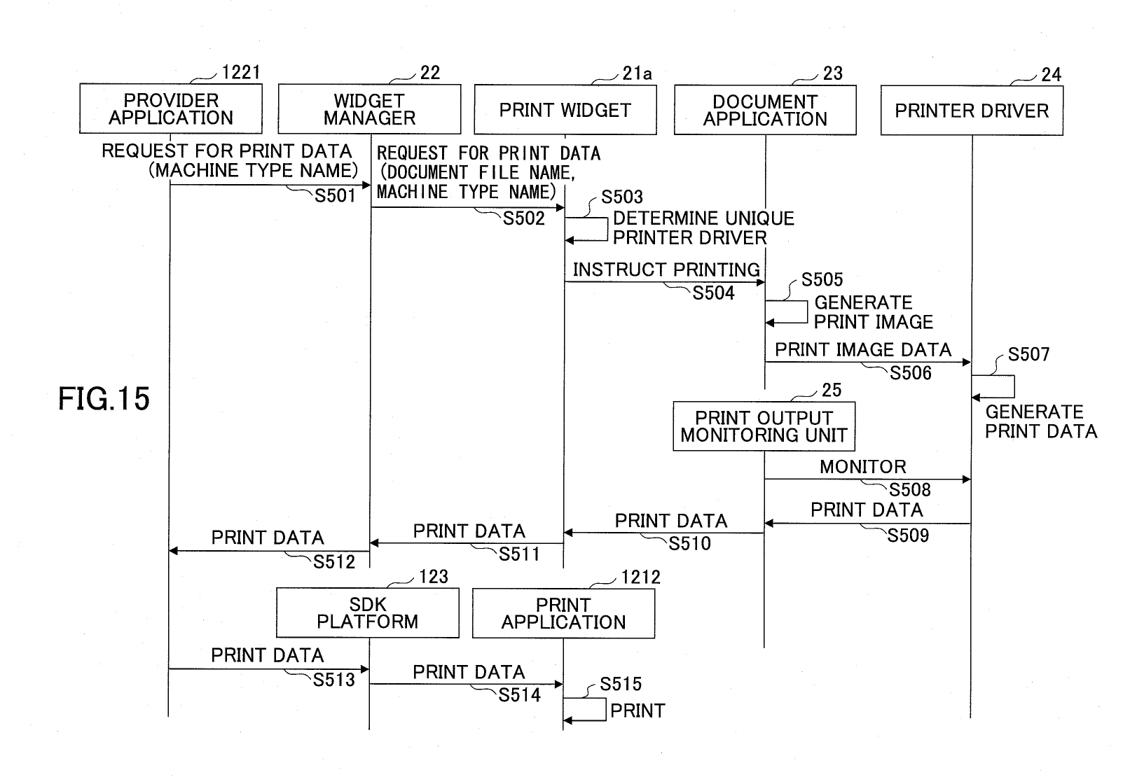

Furthermore, in the second embodiment, the processing procedures of step S312 onward of FIG. 10 are replaced by the processing procedures indicated in FIG. 15.

FIG. 15 is a sequence diagram for describing the processing procedures when a print job is executed according to the second embodiment. The processing procedures of FIG. 15 are executed after steps S301 through S311 of FIG. 10.

In step S501, the widget cooperation unit 134 of the provider application 1221 specifies the print job URI corresponding to the job name selected from the list of job names, and sends, to the widget manager 22 relevant to the print job URI, a request to acquire print data relevant to the print job (step S501). In the acquisition request, the machine type name of the image forming apparatus 10 is specified.

The acquisition request is received by the mediation unit 224 of the widget manager 22 to which the acquisition request is directed. The mediation unit 224 specifies the document file name of the print job associated with the print job URI specified in the acquisition request, and the machine type name specified in the acquisition request, and sends a request to generate print data to the print widget 21a relevant to the print job URI (step S502).

In response to the request to generate print data, the logic unit 214a of the print widget 21a determines the unique printer driver 24b corresponding to (compatible with) the machine type name specified in the generation request (step S503) the process contents of step S503 are the same as step S405 of FIG. 13. However, when there is no unique printer driver 24b that corresponds to the machine type name, the common printer driver 24a may be determined as the usage object. This is because it may be possible that the image forming apparatus 10 that is the output destination can be handled by the common printer driver 24a.

Next, the logic unit 214a inputs a print instruction in the document application 23 corresponding to the document file name specified in the request to generate print data (step S504). In the print instruction, the logical printer name that corresponds to the printer driver 24 determined at step S503 and that is set as the print widget 21a is specified as the print output destination.

Next, in steps S505 through 5510, the same processes as those of steps 5202 through S207 of FIG. 9 are executed. However, the printer driver 24 that is used is not necessarily the common printer driver 24a. This is because the unique printer driver 24b corresponding to (compatible with) the machine type name of the image forming apparatus 10 that is the output destination is selected as the priority at step S503.

Next, in steps S511 through S515, the same processes as those of steps S407 through S411 of FIG. 13 are executed. As described above, the print data to be output is most likely in a format corresponding to (compatible with) the image forming apparatus 10. Therefore, in step S515, the print process is highly likely to be successful.

As described above, in the second embodiment, the print data is not generated when the print job is registered. After the image forming apparatus 10 to be used as the output destination is determined, the print data is generated by the printer driver 24 corresponding to (compatible with) the machine type of the selected image forming apparatus 10. Therefore, it is possible to enhance the possibility of successfully printing out the print data with the image forming apparatus 10 that is initially selected as the output destination.

In the above embodiments, the machine type name of the image forming apparatus 10 is used for determining the unique printer driver 24b compatible with the image forming apparatus 10 selected as the output destination. However, any information other than the machine type name can be used, as long as the unique printer driver 24b corresponding to (compatible with) the image forming apparatus 10 can be identified. For example, the name of the unique printer driver 24b may be used instead of the machine type name.

According to one embodiment of the present invention, a printing system is provided, which is capable of enhancing convenience in a case where the output destination of a print job is not limited when a print instruction is given from a client.

The present invention is not limited to the specific embodiments described herein, and variations and modifications may be made without departing from the scope of the present invention.

The present application is based on Japanese Priority Patent Application No. 2010-254827, filed on Nov. 15, 2010, the entire contents of which are hereby incorporated herein by reference.

What is claimed is:

1. A printing system comprising:
an image forming apparatus; and
a program that causes a computer connected to the image forming apparatus via a network to execute a process, the process including
a first generating step of causing a first printer driver to generate first print data in response to receiving an electronic data print instruction, and recording the first print data in a storage unit,
a first sending step of sending the first print data to the image forming apparatus in response to a print data acquisition request from the image forming apparatus,
a second generating step of causing a printer driver identified by identification information to generate second print data, in response to receiving the identification information identifying the printer driver that is compatible with the image forming apparatus, and
a second sending step of sending the second print data to the image forming apparatus, wherein
the image forming apparatus includes
a first acquiring unit configured to acquire the first print data recorded in the storage unit,
a print control unit configured to execute a print operation based on the first print data, and
a second acquiring unit configured to send, to the computer, the identification information of the printer driver being compatible with the image forming apparatus, and to receive the second print data, when the image forming apparatus cannot print the first print data, wherein
the print control unit executes a print operation based on the second print data.

2. The printing system according to claim 1, wherein
the first printer driver generates the first print data that can be handled by plural machine types of the image forming apparatus.

3. The printing system according to claim 1, wherein
the identification information is a machine type name of the image forming apparatus.

4. The printing system according to claim 1, wherein
the identification information is a name of the printer driver that is compatible with the image forming apparatus.

5. A printing system comprising:
an image forming apparatus; and
a program that causes a computer connected to the image forming apparatus via a network to execute a process, the process including
a recording step of recording, in a storage unit, an identification name of electronic data in response to receiving an electronic data print instruction,
a first sending step of sending the identification name to the image forming apparatus in response to a request from the image forming apparatus,
a generating step of causing a printer driver identified by identification information to generate print data corresponding to the electronic data relevant to the identification name, in response to receiving the identification information identifying the printer driver and the identification name of the electronic data, the printer driver identified by the identification information being compatible with the image forming apparatus, and
a second sending step of sending the print data to the image forming apparatus, wherein
the image forming apparatus includes
a first acquiring unit configured to acquire the identification name recorded in the storage unit,
a second acquiring unit configured to send, to the computer, the identification information of the printer driver compatible with the image forming apparatus and the identification name, and to receive the print data, and
a print control unit configured to execute a print operation based on the print data.

6. A non-transitory computer-readable recording medium storing a program that causes a computer to execute the steps of:
causing a first printer driver to generate first print data in response to receiving an electronic data print instruction, and recording the first print data in a storage unit;
sending the first print data to an image forming apparatus connected to the computer via a network, in response to receiving a print data acquisition request from the image forming apparatus;
causing a printer driver identified by identification information to generate second print data in response to receiving the identification information identifying the printer driver, the printer driver being compatible with the image forming apparatus, and
sending the second print data to the image forming apparatus.
